(19) United States
(12) Patent Application Publication
(10) Pub. No.: US 2006/0085800 A1
(43) Pub. Date: Apr. 20, 2006

(54) Internal optical disk drive

(75) Inventor: Edward Chiu, Taipei (TW)

Correspondence Address: G. LINK Co., LTD., PMB 174, 931 West 75th Street, Suite 137, Naperville, IL, 60565, US

(73) Assignee: BEHAVIOR COMPUTER TECH CORP.

(21) Appl. No.: 10/966,513

(22) Filed: Oct. 18, 2004

(51) Int. Cl. G11B 33/02; G11B 17/04; G11B 17/03

(52) U.S. Cl. 720/600

(57) ABSTRACT

The present invention is related to an internal optical disk drive comprising of a panel which is equipped with at least one memory slot used for electrical connection to the memory card, and with at least one digital data extension port used for electrical connection to the electronic device. The internal optical disk drive, besides possessing the original function of conventional internal optical disk drive, further has the extensively connecting function to other electronic devices and memory cards. The electronic device inserts directly into the panel of the drive through the digital data extension port, and the memory card inserts directly into the panel of the drive through the memory slot, in order to make the computer using the internal optical disk drive have multiple access for the data.

### FIELD OF THE INVENTION

The present invention is related to an internal optical disk drive, especially to a panel equipped with both digital data extension ports and memory card slots.

### BACKGROUND OF THE INVENTION

FIG. 1 shows the perspective drawing of an internal optical disk drive. The panel 101 of internal optical disk drive 10 has a reject button 103, volume knob 105 and headphone jack 107, however, the volume knob 105 and the headphone jack 107 seems to be redundant for the user who doesn't utilize internal optical disk drive 10 to listen to music from music CD disks except the necessity of reject button 103. The computer user care about the speed of reading and writing data and the stability of reading and writing data rather than volume knob 105 and headphone jack 107.

The inventor of the present invention found out that the panel design of the internal optical disk drive has not been matched up with the habits of current computer users, so the inventor has invented such a panel equipped with both digital data extension ports and memory card slots in the internal optical disk drive and accords with currently multiple data access.

### SUMMARY OF THE INVENTION

The object of the present invention is to provide an internal optical disk drive which offers electrical connections to another electronic device and any kind of memory card on its panel.

To achieve the above purpose, the present invention provides internal optical disk drive comprises a panel which is equipped with at least one memory slot used for electrical connection to the memory card, and with at least one digital data extension port used for electrical connection to the electronic device.

### BRIEF DESCRIPTION OF DRAWINGS

The above objects and advantages of the present invention will become more apparent with reference to the appended drawings wherein:

FIG. 1 is the perspective view showing the conventional internal optical disk drive;

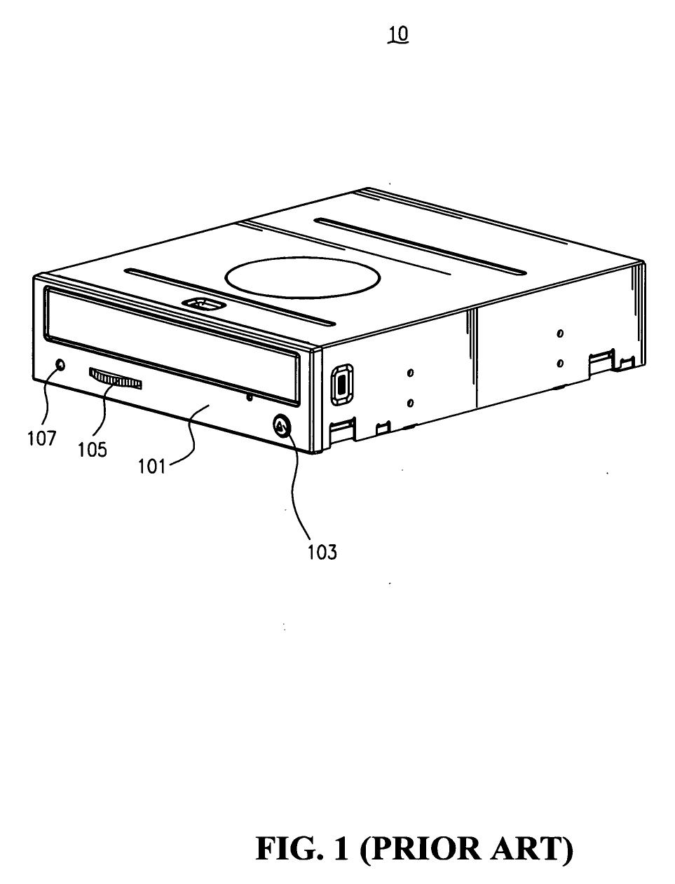

FIG. 2 is the perspective view showing the internal optical disk drive of the present invention; and

FIG. 3 is the internal structural drawing after opening the panel of the internal optical disk drive of the present invention.

### DETAILED DESCRIPTION OF THE INVENTION

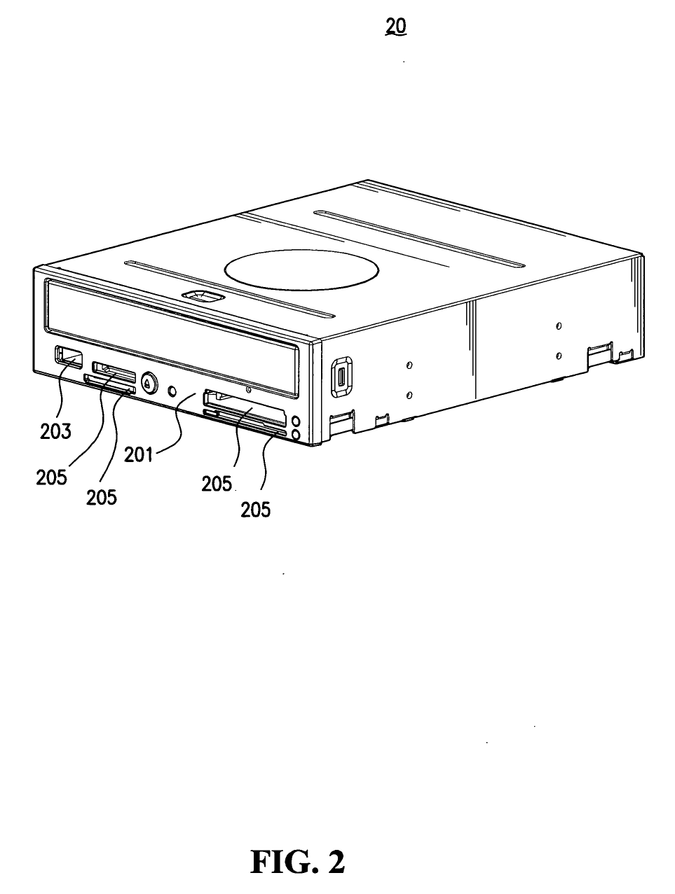

FIG. 2 shows the perspective drawing of the present invention internal optical disk drive of the present invention. The internal optical disk drive 20 of the present invention mainly comprises a panel 201, at least one digital data extension port 203 which is equipped on the panel 201, and at least a memory card slot 205 which is equipped on the panel 201. The embodiment of digital data extension port 203 is capable of either using an USB socket or IEEE1394 socket. The embodiment of memory card slot 205 is capable of using a CF memory card slot, MS memory card slot, MS Pro memory card slot, SM memory card slot, SD memory card slot, MMC memory card slot, XD memory card slot and so on. The internal optical disk drive 20 is capable of adopting used knowledge of circuit designs to control reading and writing disks.

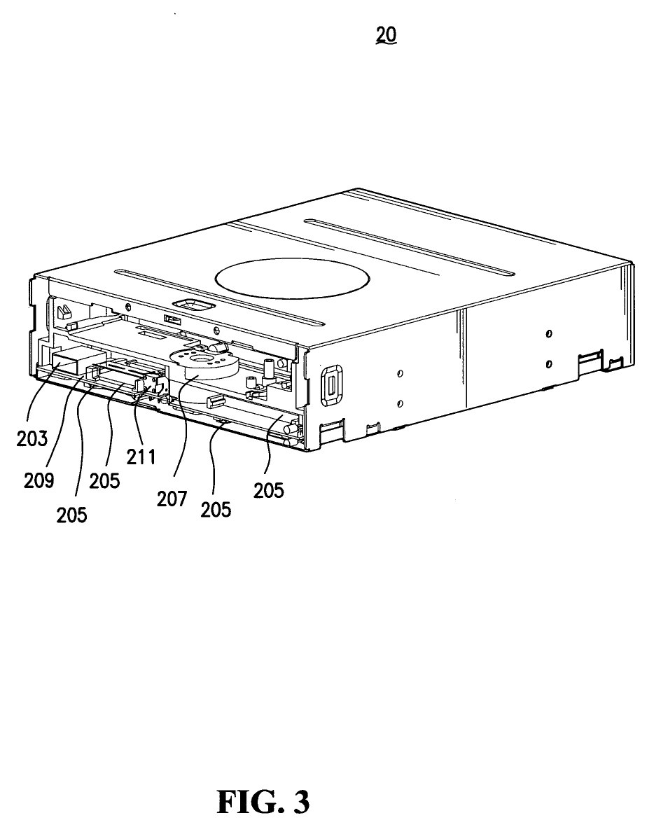

FIG. 3 shows the internal structural drawing of the internal optical disk drive of the present invention. There is at least one digital data extension port 203 soldered and fixed on the printed circuit board (PCB) 209 and also at least one memory card slot 205 soldered and fixed on the PCB 209. The equipped positions of digital data extension port 203 and memory card slot 205 can not obstruct the movement of the tray to enter and exit control mechanism 207 and also consider other devices placed on the panel 201, such as reject button and LED, it is demonstrated in FIG. 3 of internal optical disk drive 20 about the igital data extension port 203, memory card slot 205, control mechanism of tray enter/exit 207, PCB 209 and other devices to accomplish the arrangement in finite space.

Furthermore, PCB 209 solders mainly digital data extension port 203 and memory card slot 205, it also solders the electronic components on control mechanism of tray enter/exit 207, such as reject button switch 211.

The embodiment of the internal optical disk drive 20 is possible to be the internal optical disk writer, and internal half-height optical disk drive. The internal optical disk writer can possible be a DVD+R/DVD+RW/DVD-R/DVD-RW writer or CD-R/CD-RW writer.

The present invention improves the conventional internal optical disk drive 10 to get the improved internal optical disk drive 20 which has original functions of the drive 10, besides, it possesses extensively connecting functions to other electronic devices, for example, USB flash drive directly plugs into the panel 201 of the internal optical disk drive 20 through digital data extension port 203 to make the user who is using the computer with internal optical disk drive 20 access the data from USB flash drive. Consequently, by extensively connecting the function of digital data extension port 203 to versatile electronic devices increases the functionality and value of the internal optical disk drive 20, this is a merit quite different from the drive 10. There are memory slots 205 with different electrical specs on panel 201 used for the corresponding plugs of memory cards, such as CF memory card, MS memory card, MS Pro memory card, SM memory card, SD memory card, MMC memory card, XD memory card and so on. Accordingly, the present invention internal optical disk drive 20 is completely in accordance with the current requirement of multiple data access.

The quantity of digital data extension port 203 equipped on the present invention panel 201 is not limited at one, the quantity depends on the practical requirement. Similarly, the quantity of memory card slot 205 equipped on the panel 201 is not limited at one, the quantity depends on the practical requirement.

Although the embodiments of the present invention are revealed as above, this does not mean a constraint to the present invention, any modification made by any ordinary skilled person within the spirit and scope of the present invention belongs to the scope of the claims of the present invention described below.

What is claim is:

1. An internal optical disk drive, comprising:
A panel;
At least one memory card slot equipped on the panel, used for electrical connection to a memory card;
At least one digital data extension port equipped on the panel, used for electrical connection to an electronic device.

2. The internal optical disk drive according to claim 1, wherein the digital data extension port is selected from the group of an USB socket, IEEE1394 socket.

3. The internal optical disk drive according to claim 1, wherein the memory card slot is selected from the group of a CF memory card slot, MS memory card slot, MS Pro memory card slot, SM memory card slot, SD memory card slot, MMC memory card slot, XD memory card slot.

4. The internal optical disk drive according to claim 1, wherein the internal optical disk drive is an internal optical disk writer.

5. The internal optical disk drive according to claim 1, wherein the internal optical disk drive is an internal half-height optical disk drive.

6. The internal optical disk drive according to claim 1, wherein the electronic device is an USB flash drive.

7. An optical disk drive with digital data extension port, comprising:
A panel;
At least one memory card slot equipped on the panel, used for electrical connection to a memory card;
At least one digital data extension port equipped on the panel, used for electrical connection to an electronic device.

8. The optical disk drive according to claim 7, wherein the digital data extension port is selected from the group of an USB socket, IEEE1394 socket.

9. The optical disk drive according to claim 7, wherein the memory card slot is selected from the group of a CF memory card slot, MS memory card slot, MS Pro memory card slot, SM memory card slot, SD memory card slot, MMC memory card slot, XD memory card slots.

10. The optical disk drive according to claim 7, wherein the optical disk drive is an optical disk writer.

11. The optical disk drive according to claim 7, wherein the optical disk drive is a half-height optical disk drive.

12. The optical disk drive according to claim 7, wherein the electronic device is an USB flash drive.
